(19) United States
(12) Patent Application Publication
(10) Pub. No.: US 2012/0081821 A1
(43) Pub. Date: Apr. 5, 2012

(54) ESD Protection Device for Multi-Voltage System

(76) Inventor: Yan-Nan Li, New Taipei City (TW)

(21) Appl. No.: 13/237,935

(22) Filed: Sep. 21, 2011

(30) Foreign Application Priority Data
Oct. 1, 2010 (TW) 099133590

(51) Int. Cl. H02H 9/00

(52) U.S. Cl. 361/56

(57) ABSTRACT

An ESD protection device for a multi-voltage system includes a first circuit block, a second circuit block, a first power clamp circuit and a second power clamp circuit. The first and second circuit blocks respectively operate at a first power voltage and a second power voltage smaller than the first power voltage. The first power clamp circuit, coupled to the first circuit block, has a breakdown voltage between the first and second power voltages and a holding voltage greater than or equal to the first power voltage. The second power clamp circuit is smacked on the first power clamp circuit and coupled to the second circuit block. A total breakdown voltage of the first and second power clamp circuits is greater than the second power voltage, and a total holding voltage of the first and second power clamp circuits is greater than or equal to the second power voltage.

### BACKGROUND OF THE INVENTION

1. Field of the Invention

The present invention relates to an ESD protection device for a multi-voltage system, and more particularly, to an ESD protection device smacked on multi-level low-voltage or middle voltage power clamp elements to increase conduction efficiency and reduce circuit areas.

2. Description of the Prior Art

The development of semiconductor processes is ongoing. As one skilled in the art will appreciate, a modern chip is allowed to have a plurality of various electronic circuits configured within. Moreover, electronic pads are disposed on each chip for receiving an external power source (e.g., a bias current/voltage) and for exchanging data with other external electronic circuits/chips. For instance, a chip has power pads implemented for receiving bias voltage(s), and signal pads for receiving input signals and output signals. The above-mentioned signal pads are named I/O pads.

That is, the chip is connected with external electronic circuits or chips via the aforementioned electronic pads. However, during processes such as packaging, testing, delivering, and manufacturing, etc., the chip can be damaged or interfered with by the external static electricity via the electronic pads (power pads and signal pads) of the chip. External static electricity easily damages inner circuits in a chip via the electronic pads, and the unwanted condition causing the inner circuits of a chip to be damaged or interfered with is called electrostatic discharge (ESD). Providing excellent ESD protection circuits for protecting modern integrated electronic circuits (e.g., a chip) from being damaged by the unwanted ESD noise is an important issue for designers.

In general, ESD protection circuits are disposed between two pads of the chips. The said ESD protection circuits are basically implemented for providing a bypass path with a low equivalent impedance value for bypassing the ESD current. In this way, the ESD current passes through the ESD protection circuits rather than passes through inter inner circuits of the chip, thereby protecting the inner circuits of the chip from being damaged or interfered with by unwanted ESD events or current.

Please refer to FIG. 1. FIG. 1 is a schematic diagram illustrating a conventional electro-static discharge (ESD) integrated circuit 100. The integrated circuit 100 comprises a first power pad 101, a second power pad 102, a signal pad 103, a resistive element 105, an internal circuit 110, two diodes 121, 122, and a power clamp circuit 130. The power clamp circuit 130 is configured as the ESD protection circuit between the first power pad 101 (i.e., VDD) and the second power pad 102 (i.e., VSS). In addition, in FIG. 1, the diode 121 is configured as the ESD protection circuit between the signal pad 103 and the first power pad 101, and the diode 122 is configured as the ESD protection circuit between the signal pad 103 and the first power pad 102. Furthermore, the above-mentioned power clamp circuit 130 is configured as the ESD protection circuit between the first power pad 101 and the second power pad 102.

The power clamp circuit 130 comprises a gate-grounded N type metal oxide semiconductor (MOS) transistor 132 and a gate-powered P type MOS transistor 134. Conventionally, the power clamp circuit 130 can also be implemented by only the gate-grounded N type MOS transistor 132 or only the gate-powered P type MOS transistor 134.

However, in an integrated circuit of a multi-power system, particularly a system with different operating voltages such as 5-volt/12-volt /32-volt applications, internal power source systems in the integrated circuit require separate ESD protection circuits to drain static electricity to the ground, and such a conventional structure costs areas and lacks efficient conducting paths between power source systems.

For example, please refer to FIG. 2, which illustrates a schematic diagram of an ESD protection circuit 200 for a multi-power system according to the prior art. In FIG. 2, an integrated circuit includes three different power source systems, represented by power pads 201, 202, 203, and corresponding ground pads HVG, MVG, LVG, respectively. In such a situation, the ESD protection circuit 200 comprises three power clamp circuits 21, 22, 23, providing ESD protection for the power pads 201, 202, 203, and the corresponding ground pads HVG, MVG, LVG, respectively. In addition, in order to insulate noise coupling across the three power source systems, the ground contacts thereof need to be inter-connected through the ground block elements GC1, GC2. The ground block elements GC1, GC2 can be blocking resistances or bi-directional diode strings, which is well-known by those skilled in the art and not narrated hereinafter.

When static electricity subjects to the high-voltage power pad 201 and needs to be discharged from the low-voltage power pad 203, an ESD path is formed from the high-voltage power pad 201 to the high-voltage ground pad HVG through the power clamp circuit 21, and from the high-voltage ground pad HVG to the low-voltage ground pad LVG through the ground block elements GC1, GC2, and at last, from the low-voltage ground pad LVG to the low-voltage power pad 203. In general, the high-voltage power clamp circuit 21 is composed of high-voltage elements with high conducting resistances for enduring higher conducting voltage, and has longer ESD path, which causes poorer conducting efficiency. Therefore, high-voltage electrostatic protection circuits require larger areas, providing uncompromised electrostatic protection effect.

On the other hand, in the conventional design, a diode, e.g. diodes D3, D4 shown in FIG. 2, might be added between the low-voltage power source system and the high-voltage power source system, to provide an ESD path toward the high-voltage power source system for the low-voltage power source system when an electrostatic event occurs. In such a situation, when the integrated circuit starts to be powered, if the low-voltage power source is provided first, the middle-voltage power source system is in a floating state, which can easily cause a conducting path from the low-voltage power pad 203 to the middle-voltage power pad MV through the diode D3, and generate an instant current spike upon booting as well.

In short, the internal power source system of the integrated circuit often requires ESD protection circuits to drain the static electricity to the ground, which costs areas and lacks efficient conducting paths between different power source systems. Besides, the high-voltage power clamp circuit composed of high-voltage elements has an inefficient issue. In addition, for the conventional circuit structure, if the booting sequence is misplaced, it is very likely to generate instant current spikes upon booting because the diodes are forward biased, causing the conducting path from the low-voltage power source system to the high-voltage power source.

### SUMMARY OF THE INVENTION

It is therefore a primary objective of the present invention to provide ESD protection device for multi-voltage system.

The present invention discloses an electrostatic discharge (ESD) protection device for a multi-voltage system, which comprises a first circuit block, operated at a first power voltage; a second circuit block, operated at a second power voltage greater than the first power voltage; a first power clamp circuit, coupled to the first circuit block, having a breakdown voltage between the first power voltage and the second power voltage, and a holding voltage greater than or equal to the first power voltage; and a second power clamp circuit, smacked on the first power clamp circuit, and coupled to the second circuit block. A total breakdown voltage of the first power clamp circuit and the second power clamp circuit is greater than the second power voltage, and a total holding voltage of the first power clamp circuit and the second power clamp circuit is greater than or equal to the second power voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional electro-static discharge (ESD) integrated circuit.

FIG. 2 illustrates a schematic diagram of an ESD protection circuit structure for a multi-power system according to the prior arts.

FIG. 3 illustrates a schematic diagram of an ESD protection device for a multi-voltage system according to an embodiment of the present invention.

FIGS. 4 to 7 respectively illustrates schematic diagrams of ESD protection devices according embodiments of the present invention.

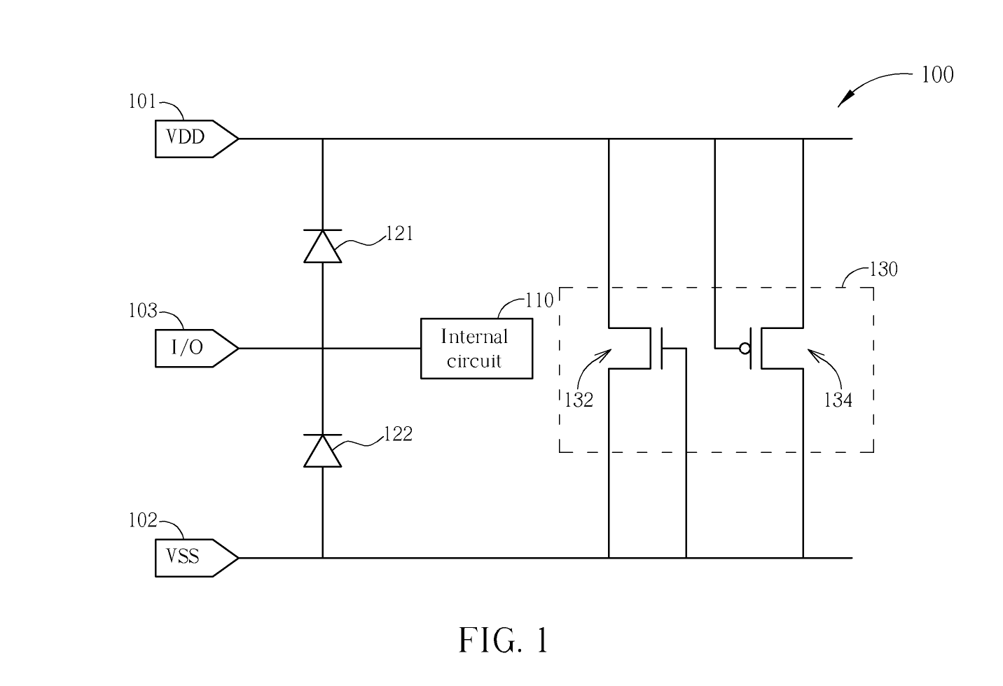

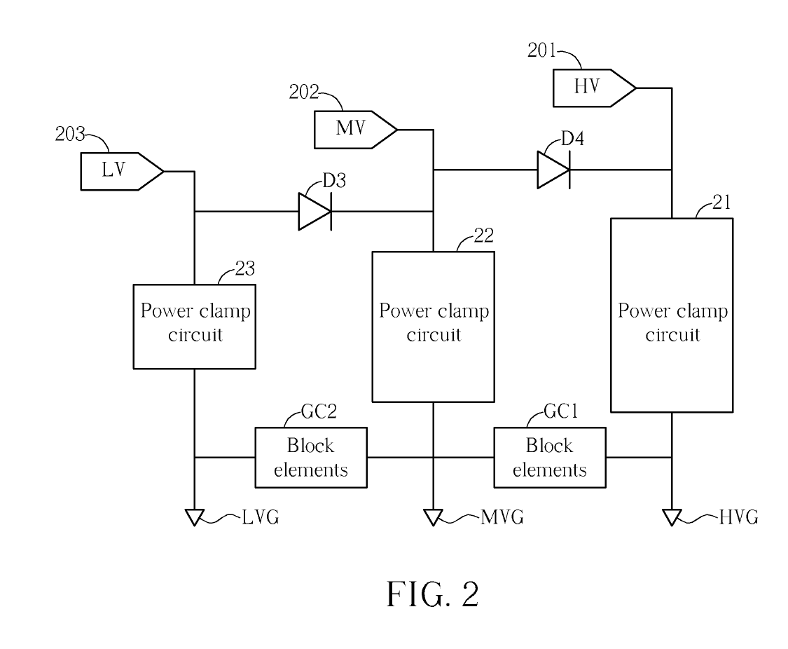

### DETAILED DESCRIPTION

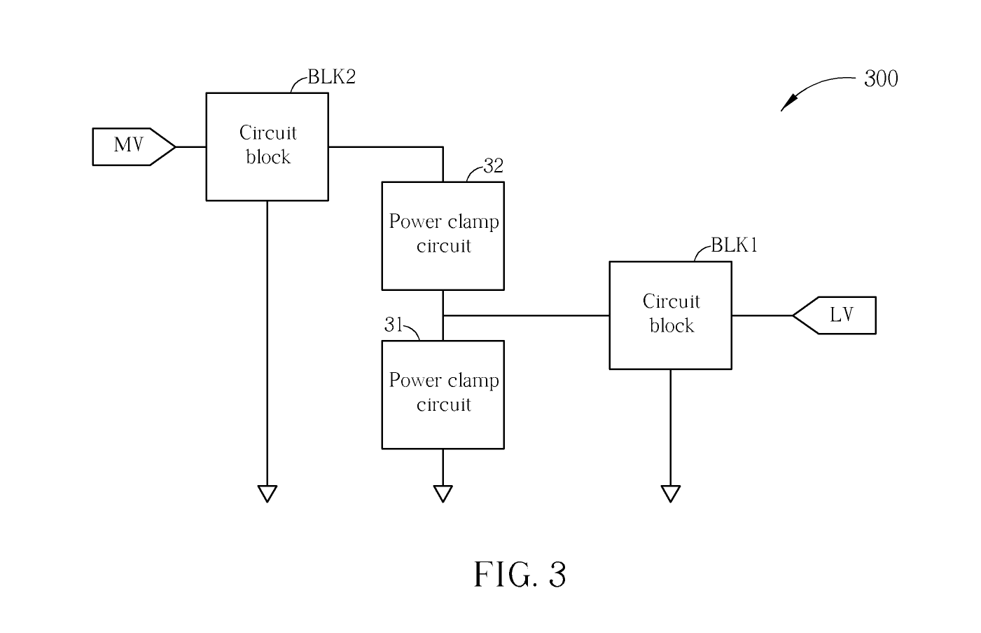

Please refer to FIG. 3, which illustrates a schematic diagram of an ESD protection device 300 for a multi-voltage system according to an embodiment of the present invention. The ESD protection device 300 includes circuit blocks BLK1, BLK2, and power clamp circuits 31, 32. The circuit blocks BLK1, BLK2 operate at power voltages LV, MV, respectively. The power voltage MV is greater than the power voltage LV. The power clamp circuit 31 is coupled to the circuit block BLK1, and the power clamp circuit 32 is coupled to the circuit block BLK2 and smacked on the power clamp circuit 31. The power clamp circuit 31 has a breakdown voltage between the power voltage MV and the power voltage LV, and a holding voltage greater than or equal to the power voltage LV. In addition, a total breakdown voltage of the power clamp circuit 31 and the power clamp circuit 32 is greater than the power voltage MV, and a holding voltage thereof is greater than or equal to power voltage MV when the source clamp circuits 31, 32 conduct simultaneously.

In other words, when the circuit block BLK1 is subjected to an ESD event greater than the breakdown voltage of the power clamp circuit 31, the power clamp circuit 31 breaks down and conducts, so as to clamp the power voltage LV at the holding voltage of the power clamp circuit 31. When the circuit block BLK2 is subjected to an ESD event greater than the total breakdown voltage of the power clamp circuits 32 and 31, the power clamp circuits 32 and 31 break down and conduct simultaneously, so as to clamp the power voltage MV at the total holding voltage of the power clamp circuits 32 and 31.

Namely, the present invention provides an ESD protection for different power source systems by smacking multi-level power clamp circuits. Therefore, the present invention may use low-voltage elements or middle-voltage elements with better protection ability, to reach conducting voltage and holding voltage required by high-voltage power clamp circuits. Consequently, the present invention can reduce circuit areas and increase efficiency. Certainly, each of the smacked power clamp circuits can be identical, partially identical or completely different according to implementation requirements, which are within the scope of the present invention as well.

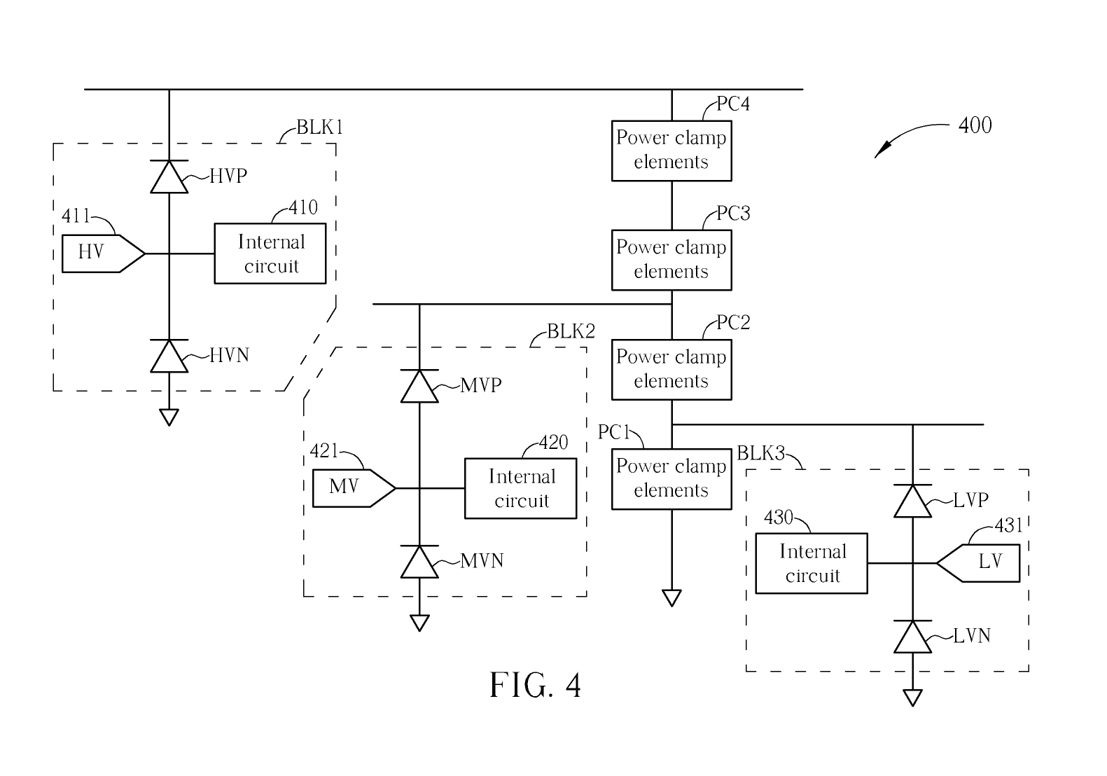

For example, please refer to FIG. 4, which illustrates a schematic diagram of an ESD protection device 400 according an embodiment of the present invention. In FIG. 4, an integrated circuit includes three different voltage systems, represented by circuit blocks BLK1-BLK3 respectively. The circuit blocks BLK1-BLK3 operate at high power voltage HV, middle power voltage MV and low power voltage LV respectively, e.g. 32 volts, 12 volts and 5 volts. The circuit blocks BLK1-BLK3 respectively include internal circuits 410, 420, 430, pads 411, 421, 431, and diodes HVP, MVP, LVP, and HVN, MVN, LVN. If the circuit blocks BLK1-BLK3 are power supply circuits, the pads 411, 421, 431 are power pads, utilized for outputting the power voltages LV, MV and HV respectively. The diodes HVP, MVP, LVP and HVN, MVN, LVN are utilized for providing ESD protection from the pads 411, 421, 431 to other voltage systems or the ground.

In such a situation, the ESD protection device 400 is utilized for providing ESD protection for the circuit blocks BLK1-BLK3, and can be composed of smacked power clamp elements PC1-PC4. Each of the power clamp elements PC1-PC4 can be implemented by low-voltage or middle-voltage elements having higher electrostatic protection efficiency. The power clamp elements PC1-PC4 form the power clamp circuit of the high-voltage circuit block BLK1, the power clamp elements PC2 and PC1 form the power clamp circuit of the middle-voltage circuit block BLK2, and the power clamp element PC1 forms the power clamp circuit of the low-voltage circuit block BLK3.

For example, if a low-voltage (e.g. 5-volt) element has 10-volt breakdown voltage and 8-volt holding voltage, the 4-level-smacked low-voltage elements PC1-PC4 can form a high-voltage power clamp circuit with 40-volt conducting voltage and 32-volt holding voltage, comprising a middle-voltage power clamp circuit (i.e. the low-voltage elements PC1 and PC2) with 20-volt conducting voltage and 16-volt holding voltage, and a low-voltage power clamp circuit (i.e. the low-voltage element PC1) with 10-volt conducting voltage and 8-volt holding voltage.

When the high-voltage power pad 411 is subjected to static electricity, requiring discharging from the low-voltage power pad 431, as shown in FIG. 4, an ESD path is formed as the power pad 411→the diode HVP (forward biased)→the power clamp elements PC4-PC2→the diode LVP (reverse biased)→the power pad 431. The conducting path only needs to pass through a 3-level-smacked power clamp element (with 30-volt conducting voltage if 5-volt element is used) and the reverse biased diode LVP (approximately 10 volts) to the ground, instead of passing through the diode HVN (with conducting voltage usually far greater than 50 volts, such as 60 volts, if 40-volt element is used), and to the low-voltage power pad 431 through the forward biased diode LVN. Therefore, using the electrostatic protection circuit formed by smacked low-voltage elements can effectively reduce conducting voltage, and enhance ESD protection ability. Similar conducting paths can also be applied to conditions, such as middle voltage to low voltage, or high voltage to middle voltage.

Therefore, comparing to the prior art which uses high-voltage elements, middle-voltage elements and low-voltage elements to respectively implement the power clamp circuits for different voltage systems, the present invention forms the power clamp circuits for different voltage systems by smacking multi-level low-voltage elements, so as to reduce circuit areas and enhance ESD protection efficiency.

In addition, the present invention also avoids instant current spikes caused by a misplaced powering sequence upon booting. When the integrated circuit is being powered, even if the low-voltage power source is powered first, current will not be able to flow into the middle-voltage and the high-voltage systems because the diodes HVP, MVP are reverse biased in view of the low-voltage system, such that the instant current spikes upon booting can be avoided.

Note that, the smacked power clamp elements PC1, PC2, PC3 and PC4 do not have to be identical, and can be adjusted according to required voltages. For example, in a 5-volt/12-volt/32-volt system, the power clamp elements PC1-PC4 can be all implemented with 5-volt elements. However, if in a 5-volt/12-volt/36-volt system, the power clamp element PC3 can be implemented by a 12-volt element with 26-volt breakdown voltage, and the power clamp element PC4 can be omitted. By such a flexible design, better ESD protection ability and minimum circuit area are achieved.

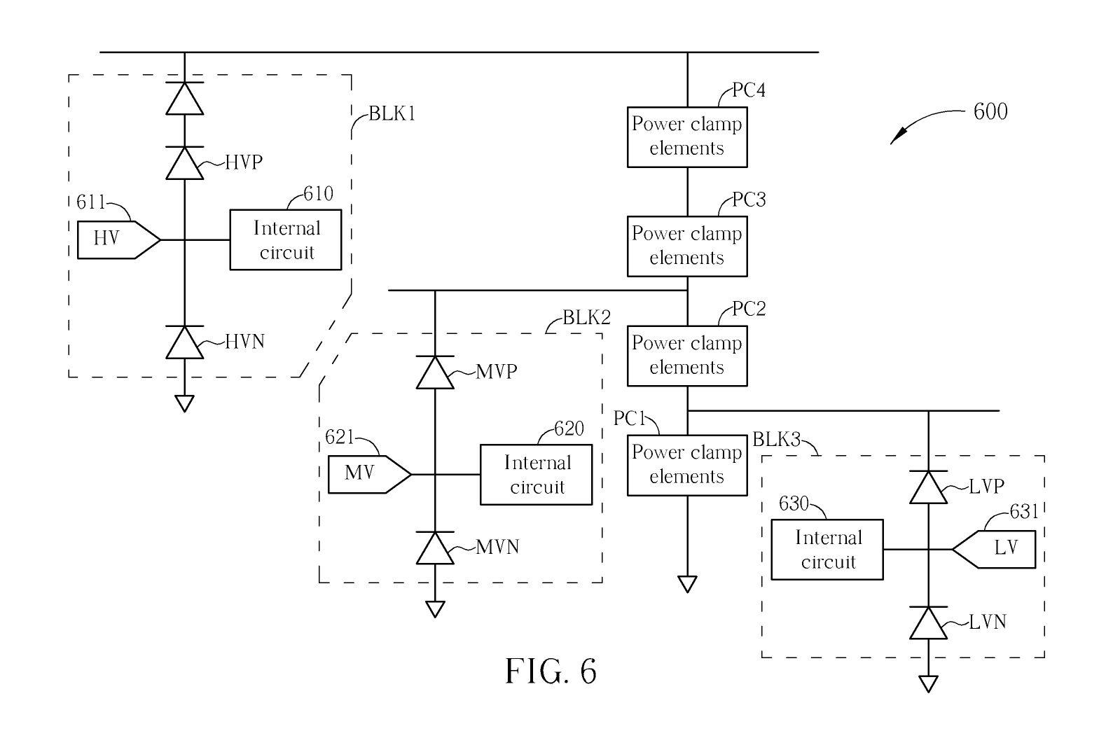

Moreover, the amount of the diodes HVP/MVP/LVP is not fixed, and can be adjusted according to requirements of voltage tolerance or holding voltage. For example, please refer to FIG. 6, which illustrates a schematic diagram of an ESD protection device 600 according to another embodiment of the present invention. If the ESD protection device 600 is applied to a 5-volt/12-volt/32-volt system, when the high-voltage system needs to expand safety margin of the holding voltage, one or more diodes HVP1 can be properly added to the circuit block BLK1. When a power pad 611 is subjected to the static electricity, since diodes HVP and HVP1 both operate in forward bias, electrostatic protection ability of the power clamp circuit is kept. Furthermore, the added diode HVP1 can also be implemented with high-voltage MOS elements.

In short, the present invention provides an ESD protection circuit for multi-power system to reduce areas and enhance efficiency, regardless of booting sequences.

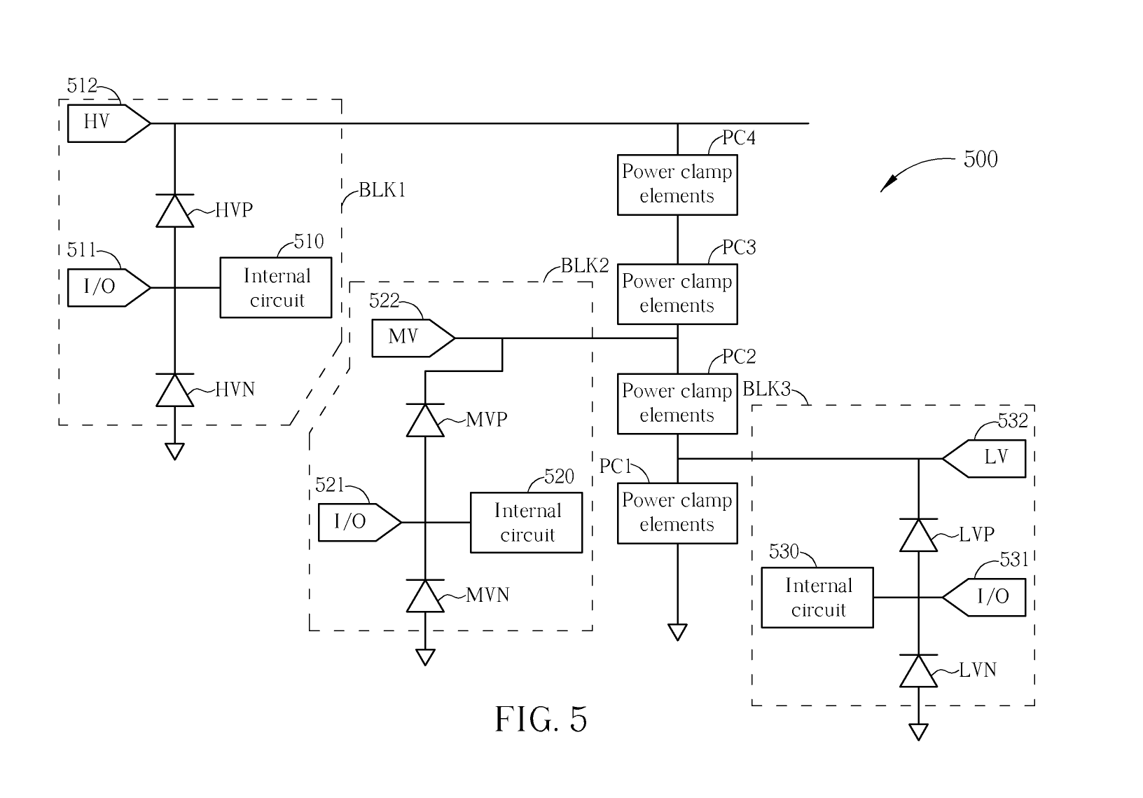

Certainly, except for the multi-power system mentioned above, the ESD device of the present invention is applicable for other multi-voltage systems. For example, please refer to FIG. 5, which illustrates a schematic diagram of an ESD protection device 500 according to another embodiment the present invention. In FIG. 5, circuit blocks BLK1-BLK3 are output-stage circuits operating at a high power voltage HV, a middle power voltage MV and a low power voltage LV respectively. In other words, pads 511, 521 and 531 are not power pads for transmitting bias voltage, but signal pads for outputting signals, also called input/output pads. In such a situation, each of the circuit blocks BLK1-BLK3 further includes a power pad respectively coupled to internal circuits 510-530 for receiving the power voltages HV, MV and LV.

In FIG. 5, when static electricity subjects to the signal pad 511 and is flowing to the low-voltage power pad 532, an ESD path is formed as the signal pad 511→the diode HVP (forward biased)→the power clamp elements PC4-PC2→the power pad 532. The conducting path only needs to pass through a 3-level smacked power clamp element (with about 30-volt conducting voltage if 5-volt element is used) to the ground, instead of passing through a high-voltage element HVN (with conducting voltage usually far greater than 50 volts, such as 60 volts, if a 40-volt element is used), and to a LV Pin through the forward biased LVN. Consequently, the present invention can effectively reduce the conducting voltage, so as to enhance ESD protection ability. Similar conducting paths can be applied to conditions, such as middle voltage to low voltage, or high voltage to middle voltage.

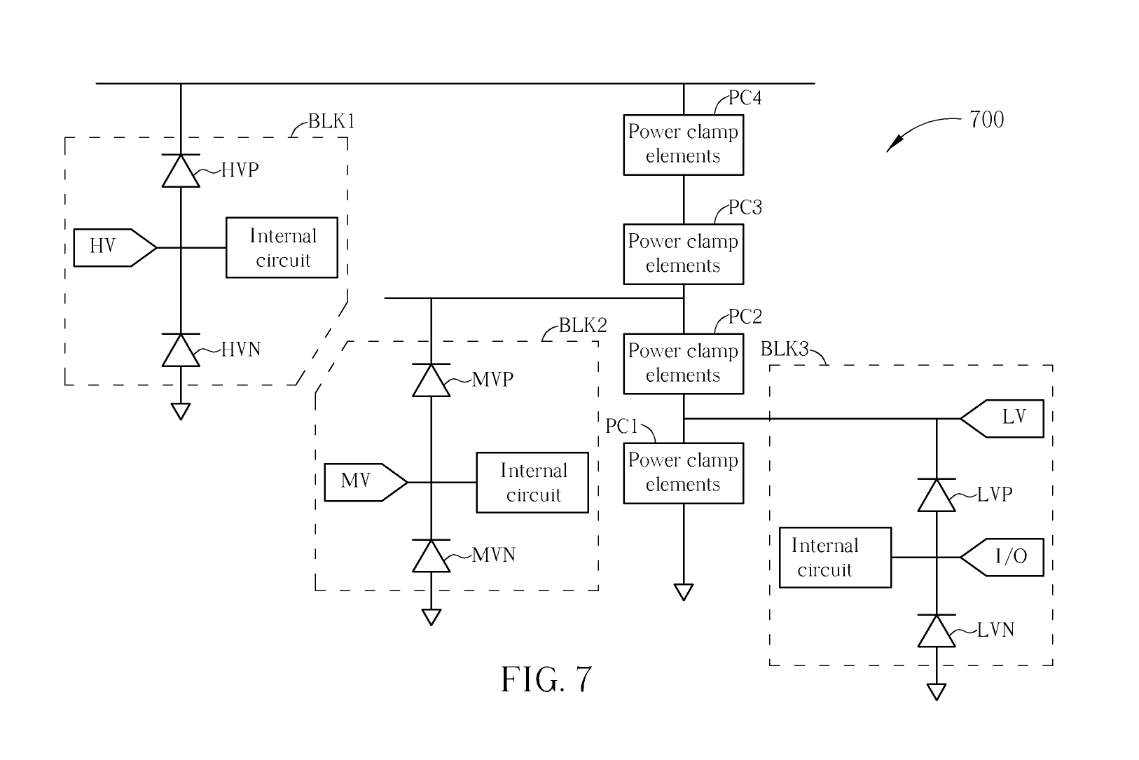

Please continue to refer to FIG. 7, which illustrates a schematic diagram of an ESD protection device 700 according to another embodiment of the present invention. The ESD protection device 700 is an embodiment combining the ESD protection devices 400 and 500. Comparing to FIG. 4 and FIG. 5, the ESD protection device 700 replaces the low-voltage circuit block BLK3 in the ESD protection device 400 with the one in FIG. 5, which is a common structure of a boost circuit. Such modification is within the scope of the present invention.

Those skilled in the art should readily recognize that the high-voltage elements and low-voltage elements in the present invention can be defined by threshold voltage, gate oxide thickness, junction breakdown voltage, well doping density, static leakage current of transistors or any combinations of the above mentioned. In the above-mentioned embodiments, the low-voltage elements and the high-voltage elements (i.e. discharge transistor) are manufactured by the same semiconductor manufacturing procedure, and in other embodiments, they may be manufactured by different semiconductor manufacturing procedures, which is within the scope of the present invention.

To sum up, the present invention smacks multi-level low-voltage elements to form the power clamp circuits for different voltage systems. Comparing to the prior art using high-voltage, middle-voltage and low-voltage elements to respectively implement the power clamp circuits for different voltage systems, the present invention reduces circuit areas and enhances ESD protection efficiency.

Those skilled in the art will readily observe that numerous modifications and alterations of the device and method may be made while retaining the teachings of the invention.

What is claimed is:

1. An electrostatic discharge (ESD) protection device for a multi-voltage system, comprising:
a first circuit block, operated at a first power voltage;
a second circuit block, operated at a second power voltage greater than the first power voltage;
a first power clamp circuit, coupled to the first circuit block, having a breakdown voltage between the first power voltage and the second power voltage, and a holding voltage greater than or equal to the first power voltage; and
a second power clamp circuit, smacked on the first power clamp circuit, and coupled to the second circuit block, wherein a total breakdown voltage of the first power clamp circuit and the second power clamp circuit is greater than the second power voltage, and a total holding voltage of the first power clamp circuit and the second power clamp circuit is greater than or equal to the second power voltage.

2. The ESD protection device of claim 1, wherein the first power clamp circuit and the second power clamp circuit have the same breakdown voltage and holding voltage.

3. The ESD protection device of claim 1, wherein the first power clamp circuit and the second power clamp circuit have different breakdown voltages and holding voltages.

4. The ESD protection device of claim 1, wherein the first power clamp circuit and the second power clamp circuit are composed of at least one power clamp elements respectively.

5. The ESD protection device of claim 1, wherein each of the power clamp elements is a low-voltage element.

6. The ESD protection device of claim 1, wherein when the first circuit block is subjected to an ESD event greater than the breakdown voltage of the first power clamp circuit, the first power clamp circuit breaks down and conducts, and the first power voltage is clamped at the holding voltage of the first power clamp circuit.

7. The ESD protection device of claim 1, wherein when the second circuit block is subjected to an ESD event greater than the total breakdown voltage of the second power clamp circuit and the first power clamp circuit, the first power clamp circuit and the second power clamp circuit simultaneously break down and conduct, and the second power voltage is clamped at the total holding voltage of the first power clamp circuit and the second power clamp circuit.

8. The ESD protection device of claim 1, wherein the first circuit block comprises:
a first internal circuit;
a first pad, coupled to the first internal circuit; and
a first diode, having an anode coupled to the first pad, and a cathode coupled to the first power clamp circuit.

9. The ESD protection device of claim 8, wherein the first pad is a signal pad.

10. The ESD protection device of claim 9, wherein the first circuit block further comprises a power pad, coupled to the cathode of the first diode and the first power clamp circuit, for receiving the first power voltage.

11. The ESD protection device of claim 8, wherein the first pad is a power pad, for receiving the first power voltage.

12. The ESD protection device of claim 1, wherein the second circuit block comprises:
a second internal circuit;
a second pad, coupled to the second internal circuit; and
a second diode, having an anode coupled to the second pad, and a cathode coupled to the second power clamp circuit.

13. The ESD protection device of claim 12, wherein the second pad is a signal pad.

14. The ESD protection device of claim 13, wherein the second circuit block further comprises a power pad, coupled to the cathode of the second diode and the second power clamp circuit, for receiving the second power voltage.

15. The ESD protection device of claim 12, wherein the second pad is a power pad, for receiving the second power voltage.
